(19) United States
(12) Patent Application Publication
(10) Pub. No.: US 2026/0326220 A1
(43) Pub. Date: Oct. 22, 2026

(54) METHOD FOR BEVEL GEAR GRINDING AND BEVEL GEAR GRINDING MACHINE

(71) Applicant: Klingelnberg GmbH, Hückeswagen (DE)

(72) Inventors: Norbert KROLL, Halver (DE); Timon RABANUS, Hueckeswagen (DE); Rolf SCHALASTER, Wermelskirchen (DE)

(21) Appl. No.: 19/652,611

(22) Filed: Apr. 20, 2026

(30) Foreign Application Priority Data
Apr. 22, 2025 (DE) 10 2025 115 475.9

(51) Int. Cl. B23F 9/02

(52) U.S. Cl. CPC B23F 9/025

(57) ABSTRACT

A method including the following steps of: grinding a bevel gear toothing using a grinding tool, wherein tooth gaps of the bevel gear toothing are machined in a first cycle in a first sequence and the tooth gaps of the bevel gear toothing are machined in a second cycle in a second sequence, and wherein the second sequence corresponds to an inversion of the first sequence.

### CROSS-REFERENCE TO RELATED APPLICATIONS

This application claims the benefit of German patent application no. 10 2025 115 475.9, filed on 22 Apr. 2025, the disclosure of which is incorporated herein by reference in its entirety.

### TECHNICAL FIELD

The present disclosure relates to a method comprising the following steps: grinding a bevel gear toothing using a grinding tool, wherein tooth gaps of the bevel gear toothing are machined in a first cycle in a first sequence and the tooth gaps of the bevel gear toothing are machined in a second sequence in a second cycle. The disclosure also relates to a bevel gear grinding machine.

### BACKGROUND

Documents EP3348354A1 and EP2647459A1 each describe methods for bevel gear grinding with eccentric motion. The eccentric motion serves, for example, to prevent grinding burn and to prevent the grinding wheel from clogging with metal particles. Furthermore, by selecting a suitable eccentric ratio, a reduction in periodic surface structures can be achieved in order to improve the noise behavior of the bevel gear.

In bevel gear grinding with eccentric motion, the stock removal, i.e., the amount of material removed by cutting, depends on the wear condition of the grinding wheel, i.e., on the number of tooth gaps produced since the last dressing. This wear causes a pitch jump between the first and last ground tooth gap, as the grinding wheel removes less material from the bevel gear workpiece when worn.

If grinding is carried out in several cycles and each cycle is started in the same tooth gap, the pitch error resulting from the wear of the grinding tool can increase from cycle to cycle, because the sharp grinding wheel is used to grind the first tooth gap with a smaller allowance and the blunt grinding wheel is used to grind the narrower tooth gaps with a larger allowance.

One approach to reducing this pitch error is to specify a start offset from one cycle to the next. This means that grinding is started in different tooth gaps for successive cycles. If grinding is carried out in several cycles with such a start offset between the first ground tooth gaps ground in the respective cycle, pitch jumps resulting from previous cycles are still clearly visible. This effect occurs primarily in bevel gear grinding with eccentric motion.

### SUMMARY

Against this background, the present disclosure is based on the technical problem of specifying an improved method for bevel gear grinding, which in particular enables improved compensation for the wear-related pitch error, especially for bevel gear grinding with eccentric motion. Furthermore, a bevel gear grinding machine for carrying out such a method is to be specified.

The technical problem described above is solved in each case by the features of the independent claims. Further designs of the disclosure are apparent from the dependent claims and the following description.

According to a first aspect, the disclosure relates to a method comprising the following steps: grinding a bevel gear toothing using a grinding tool, wherein tooth gaps of the bevel gear toothing are machined in a first sequence in a first cycle and the tooth gaps of the bevel gear toothing are machined in a second sequence in a second cycle. The method is characterized in that the second sequence corresponds to an inversion of the first sequence.

The fact that the tooth gaps for the second cycle are machined in the reverse order to the first sequence results in a smaller pitch jump. This applies in particular to cases where the grinding tool is dressed between cycles.

A cycle is defined here as the machining of all tooth gaps of the gear, If the bevel gear toothing has 20 tooth gaps, for example, a cycle is completed when all 20 tooth gaps have been ground once.

The grinding tool can be dressed after the first cycle and before the second cycle. It may be provided that the grinding tool is dressed after each cycle. It may be provided that the grinding tool is not dressed during a cycle.

Alternatively, it may be provided that dressing of the grinding tool is also required during a cycle. For example, it may be specified that the grinding tool must be dressed after grinding the tenth tooth gap before the remaining ten tooth gaps are ground, as regards the above example of a bevel gear with 20 tooth gaps. After completing the cycle, i.e., grinding all 20 tooth gaps, the tool is dressed again so that the next cycle can be performed in reverse order with the newly dressed grinding tool, wherein the tool is dressed again after grinding the tenth gap for this cycle.

The partial strategy according to the disclosure has the advantage that the tooth gaps are ground alternately with sharp and less sharp grinding tools from cycle to cycle, so that on average essentially the same material removal results for all tooth gaps. The pitch error resulting from the wear of the grinding tool can be significantly reduced in this way.

It may be provided that the tooth gaps of the bevel gear toothing are machined in further cycles following the second cycle, alternating between the first sequence and the second sequence, so that the tooth gaps are machined in successive cycles, each in reverse order.

The bevel gear toothing can be ground in a plurality of cycles, wherein roughing can first be performed in two or more cycles and then finishing can be performed in two or more cycles. Across all of these cycles, the sequence of machining the tooth gaps for successive cycles can be performed in reverse order.

It may be provided that, according to the first sequence, immediately adjacent tooth gaps are machined consecutively. If the tooth gaps of the bevel gear toothing are numbered consecutively, for example, counterclockwise with 1, 2, . . . , n, wherein “n” corresponds to the number of tooth gaps, these tooth gaps are machined consecutively according to the first sequence with 1, 2, . . . , n−1, n. This results in the second sequence as an inversion of the first sequence to n, n−1, . . . , 2, 1. The tooth gaps are therefore machined for the second cycle according to the second sequence with n, n−1, . . . , 2, 1.

Alternatively, it may be provided that tooth gaps that are offset from each other by a jump width are processed consecutively according to the first sequence.

If, for example, it is assumed that the bevel gear toothing has 19 tooth gaps, that the tooth gaps of the bevel gear are numbered consecutively in a counterclockwise direction with 1, 2, . . . , 19, and that the jump width is 2, then machining can be performed according to the first sequence with 1, 3, 5, 7, 9, 11, 13, 15, 17, 19, 2, 4, 6, 8, 10, 12, 14, 16, 18. This results in the second sequence as an inversion of the first sequence to 18, 16, 14, 12, 10, 8, 6, 4, 2, 19, 17, 15, 13, 11, 9, 7, 5, 3, 1. The tooth gaps are therefore machined for the second cycle according to the second sequence with 18, 16, 14, 12, 10, 8, 6, 4, 2, 19, 17, 15, 13, 11, 9, 7, 5, 3, 1.

If, for example, it is assumed that the bevel gear has 16 tooth gaps, that the tooth gaps of the bevel gear are numbered counterclockwise in sequence with 1, 2, . . . , 16, and that the jump width is 5, then machining can be carried out according to the first sequence with 1, 6, 11, 16, 5, 10, 15, 4, 9, 14, 3, 8, 13, 2, 7, 12. This results in the second sequence as an inversion of the first sequence to 12, 7, 2, 13, 8, 3, 14, 9, 4, 15, 10, 5, 16, 11, 6, 1. The tooth gaps are therefore machined for the second cycle according to the second sequence with 12, 7, 2, 13, 8, 3, 14, 9, 4, 15, 10, 5, 16, 11, 6, 1.

In particular, an odd jump width can be selected for an even number of tooth gaps, while an even jump width can be selected for an odd number of tooth gaps.

Alternatively, it may be provided that, according to the first sequence, tooth gaps that are offset from each other by different jump widths are processed consecutively. For example, assuming that the bevel gear toothing has 19 tooth gaps, that the tooth gaps of the bevel gear are numbered consecutively in a counterclockwise direction with 1, 2, . . . , 19, and that the jump widths are different, machining can be performed according to the first sequence with 1, 3, 9, 11, 17, 19, 6, 8, 14, 16, 5, 7, 13, 15, 2, 4, 10. This results in the second sequence as an inversion of the first sequence to 10, 4, 2, 15, 13, 7, 5, 16, 14, 8, 6, 19, 17, 11, 9, 3, 1. The tooth gaps are therefore machined in the second cycle according to the second sequence with 10, 4, 2, 15, 13, 7, 5, 16, 14, 8, 6, 19, 17, 11, 9, 3, 1.

Alternatively, it may be provided that tooth gaps are processed consecutively according to the first sequence, wherein the first sequence is specified by the user. If, for example, it is assumed that the bevel gear toothing has 16 tooth gaps, that the tooth gaps of the bevel gear toothing are numbered consecutively in a counterclockwise direction with 1, 2, . . . , 16 and are processed in a user-defined manner, then processing according to the first sequence can be carried out, for example, with 3, 9, 13, 8, 5, 6, 15, 7, 12, 11, 14, 4, 1, 16, 10, 2. This results in the second sequence as an inversion of the first sequence to 2, 10, 16, 1, 4, 14, 11, 12, 7, 15, 6, 5, 8, 13, 9, 3. The tooth gaps are therefore machined for the second cycle according to the second sequence with 2, 10, 16, 1, 4, 14, 11, 12, 7, 15, 6, 5, 8, 13, 9, 3.

All of the above numerical examples serve as illustrations to aid understanding of the disclosure. It is understood that the above procedures can also be applied to bevel gear toothings with a larger or smaller number of gaps.

It may be provided that an eccentric motion is superimposed on the rotation of the grinding tool. Investigations by the applicant have shown that the partial strategy according to the disclosure is particularly advantageous in connection with bevel gear grinding with eccentric motion, since here the stock removal, i.e., the amount of material removed by cutting, is very strongly dependent on the wear condition of the grinding tool.

The eccentric motion can be adjustable, wherein the tooth gaps are machined in the first cycle with a first eccentric motion and the tooth gaps are machined in the second cycle with a second eccentric motion, wherein the second eccentric motion has a smaller or larger eccentric stroke compared to the first eccentric motion.

The grinding tool can be a dressable cup grinding wheel.

After the first cycle and before the second cycle, the grinding tool can be dressed. It can be provided that the grinding tool is dressed after each cycle. It can be provided that the grinding tool is not dressed during a cycle.

Grinding can be performed as a plunging motion with single indexing.

Grinding can be performed as a generating motion with single indexing.

According to a second aspect, the disclosure relates to a bevel gear grinding machine having a tool spindle for accommodating a grinding tool, having a workpiece spindle for accommodating a bevel gear, and having a control device for controlling relative movements for machining bevel gears by cutting and grinding. The bevel gear grinding machine is characterized in that the control device is set up to carry out a method according to the disclosure.

### BRIEF DESCRIPTION OF DRAWINGS

The disclosure is described in more detail below with reference to drawings. The following are examples and schematic representations:

FIG. 1 shows a bevel gear;

FIG. 2 shows the bevel gear from FIG. 1 with a cup grinding wheel;

FIG. 3 shows the cup grinding wheel from FIG. 2 in cross-section;

FIG. 4 shows method steps; and

FIG. 5 shows a bevel gear grinding machine.

### DETAILED DESCRIPTION OF DRAWINGS

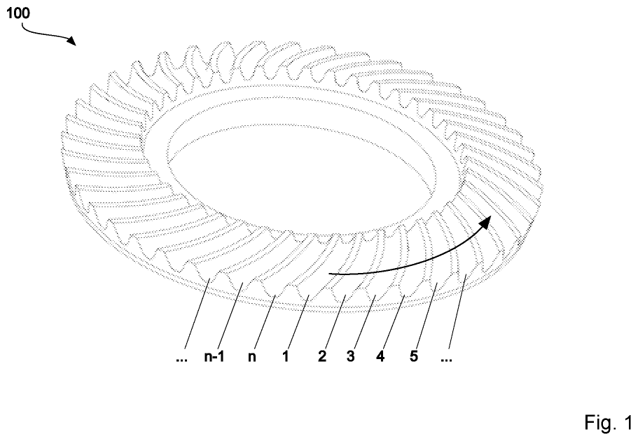

FIG. 1 shows a bevel gear 100 in a perspective view. The tooth gaps of the bevel gear 100 are numbered counterclockwise from 1 to n.

According to the disclosure, the bevel gear 100 is ground using a grinding tool, wherein the tooth gaps 1 to n of the bevel gear toothing are machined in a first cycle in a first sequence. In the present case, the first sequence is in ascending order from 1 to n. This means that immediately adjacent tooth gaps are machined in succession in a counterclockwise direction, starting with tooth gap number 1, i.e., by plunging or generating in a single indexing method.

The tooth gaps 1 to n of the bevel gear 100 are machined in a second cycle in a second sequence, wherein the second sequence corresponds to an inversion of the first sequence. The second sequence therefore corresponds to machining in descending order from n to 1. This means that adjacent tooth gaps are machined consecutively in a clockwise direction, starting with tooth gap number n.

A subsequent third cycle is performed again in the first sequence, starting with tooth gap 1. The grinding tool is dressed between each cycle.

It is understood that the first sequence can also be specified with a jump width or user-defined as desired. The decisive factor is that the second sequence is an inversion of the first sequence.

The partial strategy according to the disclosure has the advantage that the tooth gaps are ground alternately with sharp and less sharp grinding tools from cycle to cycle, so that on average, essentially the same material removal results for all tooth gaps. The pitch error resulting from the wear of the grinding tool can be significantly reduced in this way.

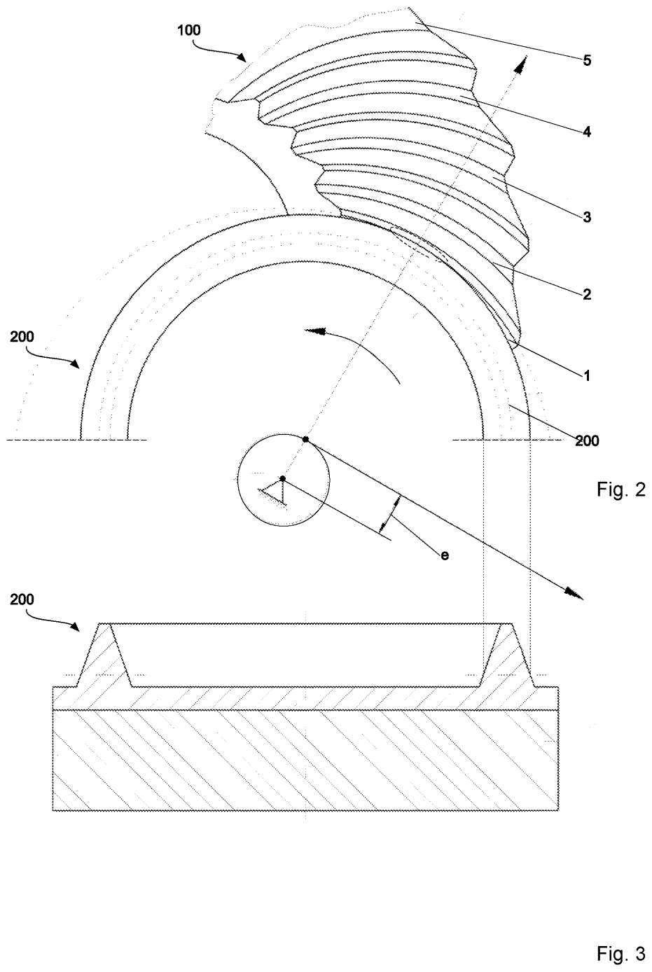

FIGS. 2 and 3 show, by way of example and schematically, a grinding tool 200 which is a dressable cup grinding wheel. The grinding tool 200 is used for grinding the tooth gaps 1 to n of the bevel gear 100.

Grinding can be carried out, for example, as plunge grinding with eccentric motion,

Eccentric plunge grinding is a discontinuous process in which the bevel gear workpiece 200 does not rotate during grinding. During plunge grinding, only a relative depth feed is performed, while an eccentricity e is superimposed on the rotational movement of the cup grinding wheel 200. A snapshot of eccentric plunge grinding is shown in FIG. 2.

The method can also be applied to eccentric generatinggrinding. The methods of eccentric plunge grinding and eccentric gear grinding are known, reference being made to EP3348354A1 in this regard. The core of the disclosure is the described inverse machining sequence of the tooth gaps for successive cycles.

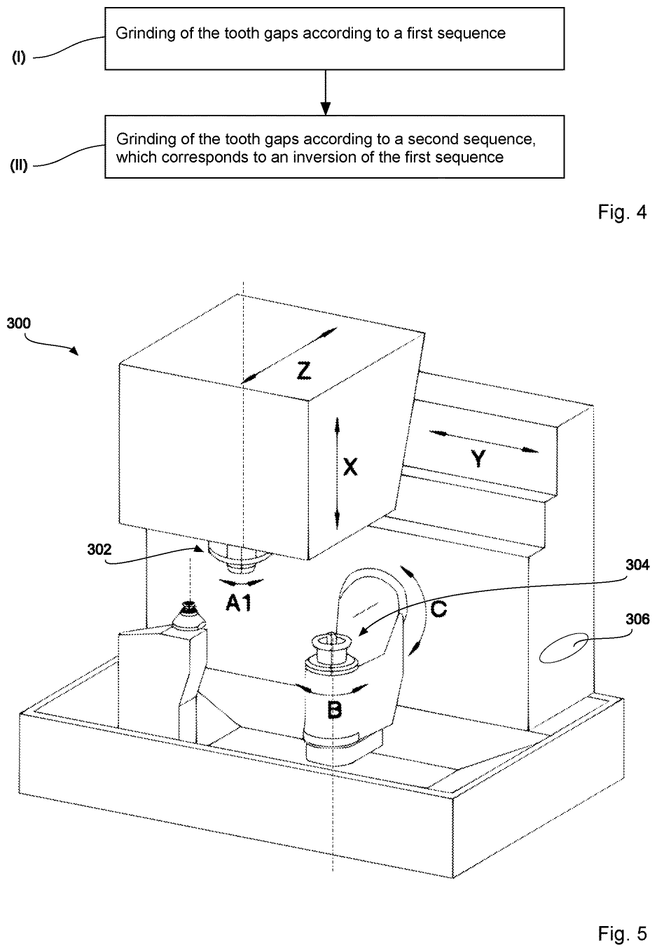

According to the disclosure, a method can therefore be specified with the following steps (FIG. 4);
(I) Grinding a bevel gear 100 using a grinding tool 200, wherein tooth gaps 1-n of the bevel gear 100 are machined in a first cycle in a first sequence, and
(II) grinding the tooth gaps 1-n of the bevel gear 100 in a second cycle in a second sequence, wherein the second sequence corresponds to an inversion of the first sequence.

FIG. 5 shows a bevel gear grinding machine 300, having a tool spindle 302 for accommodating a grinding tool, having a workpiece spindle 304 for accommodating a bevel gear, and having a control device 306 for controlling relative movements for chip-removing, grinding bevel gear machining, wherein the control device 306 is set up to carry out the method according to the disclosure.

The bevel gear grinding machine 300 has machine axes X, Y, Z, A1, B, C, which are designed to perform relative movements for cutting, grinding bevel gear machining in order to bring a grinding tool accommodated on the tool spindle 302, such as the cup grinding wheel 200, into cutting grinding contact with a bevel gear accommodated on the workpiece spindle 304, such as the ring gear 100, as indicated in the snapshot according to FIG. 2.

1. A method including the following the steps: grinding a bevel gear toothing using a grinding tool, wherein tooth gaps of the bevel gear toothing are machined in a first cycle in a first sequence and the tooth gaps of the bevel gear toothing are machined in a second cycle in a second sequence, whereby the second sequence corresponds to an inversion of the first sequence.

2. The method according to claim 1, whereby
the tooth gaps of the bevel gear toothing are machined in further cycles following the second cycle, alternating between the first sequence and the second sequence, so that the tooth gaps are machined in successive cycles with inverse sequence in each case.

3. The method according to claim 1, whereby
tooth gaps that are directly adjacent to each other are machined consecutively according to the first sequence, or
tooth gaps that are offset from each other by a jump width are processed consecutively according to the first sequence, or
tooth gaps that are offset from each other by different jump widths are processed consecutively according to the first sequence, or
tooth gaps are processed consecutively according to the first sequence, wherein the first sequence is specified by the user.

4. The method according to claim 1, whereby
an eccentric motion is superimposed on the rotation of the grinding tool.

5. The method according to claim 4, whereby
the eccentric motion is adjustable, wherein the tooth gaps are machined in the first cycle with a first eccentric motion and wherein the tooth gaps are machined in the second cycle with a second eccentric motion, wherein the second eccentric motion has a smaller or larger eccentric stroke compared to the first eccentric motion.

6. The method according to claim 1, whereby
the grinding tool is a dressable cup grinding wheel.

7. The method according to claim 6, whereby
dressing of the grinding tool is carried out after the first cycle and before the second cycle.

8. The method according to claim 1, whereby
grinding is performed as a plunging motion with single indexing, or grinding is performed as a generating motion with single indexing.

9. A bevel gear grinding machine comprising:
a tool spindle for accommodating a grinding tool,
a workpiece spindle for accommodating a bevel gear, and
a control device for controlling relative movements for machining bevel gears by cutting and grinding, wherein
the control device is designed to carry out a method according to claim 1.
